(19) United States
(12) Patent Application Publication
(10) Pub. No.: US 2017/0242885 A1
(43) Pub. Date: Aug. 24, 2017

(54) METHOD, SYSTEM AND COMPUTER-READABLE MEDIUM FOR OBTAINING A STRUCTURED QUERY FROM A SEARCH STRING

(71) Applicant: LUMANETIX PTY LTD, Melbourne (AU)

(72) Inventor: Nino SVONJA, Melbourne (AU)

(21) Appl. No.: 15/511,157

(22) PCT Filed: Sep. 14, 2015
(86) PCT No.: PCT/AU15/50542

§ 371 Date: Mar. 14, 2017

(30) Foreign Application Priority Data
Sep. 15, 2014 (AU) 2014903668

(51) Int. Cl. G06F 17/30; G06F 17/27

(52) U.S. Cl. CPC G06F 17/30389; G06F 17/30336; G06F 17/2705; G06F 17/30985; G06F 17/3053

(57) ABSTRACT

There is provided a method of obtaining a structured query from a search string, comprising: obtaining a functional representation from a parametric representation of the search string according to a functional query index; and obtaining a structured query from the functional representation according to a structured query profile. There is also provided a system for obtaining a structured query from a search string, comprising: a functional query module configured to obtain a functional representation from a parametric representation of the search string according to a functional query index; and a relevance module configured to obtain a structured query from the functional representation according to a structured query profile.

### FIELD OF INVENTION

The present invention relates to a method, system and computer-readable medium for obtaining a structured query from a search string.

### BACKGROUND ART

Websites with information retrieval (IR) capabilities are often implemented with search criteria forms to facilitate user input of search queries. For example, an interface of a website for the purpose of real estate services may be implemented with a search criteria form associated with a search facility (e.g. a database, a search index or the like) and containing a plurality of form elements, such as a drop-down menu for property type, an input field for price, and checkboxes for amenities. Conventionally, the search facility performs searches on multiple dimensions of data associated therewith based on a structured query generated according to a result of user manipulation of the search criteria form.

The disadvantages of such arrangements are, from an implementation perspective, the search criteria form is related to a single structured query in a static, pre-defined way. It is therefore difficult to dynamically change the composition including detailed parametric functional instructions, structure and relevance models of the query at runtime in a dynamic way to suit all aspects of the user intent, as required for accessing different dimensions of the data. Furthermore in systems that aggregate many data sources of different structure, it would be difficult and impractical to create a single static structured query that caters for all the competing dimensions while maintaining a generic or highly granular level of definition that is mandatory for any real level of precision in data retrieval. The same problem is manifest in the search criteria form where the screen real estate severely limits the number of input filters that can be displayed to capturer user intent. Without a method to dynamically present only the relevant criteria or appropriate structure, search on data sets with broad structure or many fields becomes unfeasible. Furthermore without a single overarching free text field it would be impossible to track how unspecified arbitrary users input relates to precise intent embodied in structured queries created from search criteria forms.

Depending on arrangement of the form elements and nature of a query, entering of a search query using the search criteria form may be time consuming due to the need for multiple cursor operations. Moreover, where arrangement of the search criteria form is improper, locating form elements of interest may be difficult. Moreover when the underlying data increases in complexity of structure and breadth of possible functional operations, it becomes difficult and prohibitive to create search criteria forms extensive enough to cater for all representations and permutations of input variables required to drive precise retrieval. Furthermore search criteria forms by nature are restrictive, as they do not cater for unspecified arbitrary user input.

Accordingly, some websites further employ input fields to permit user input of search queries in the form of search strings, where the search strings are handled by conventional natural language processing (NLP) facilities for ascertaining semantic meanings. However, implementation of such conventional NLP facilities can be time consuming and difficult. Specifically, during implementation, much effort needs to be put into building complex decision trees. Furthermore, such a conventional method is designed for compiling a static linguistic understanding that maps free-text permutations to conversational intent indicators to disambiguate ‘what’ the user might be looking for in the given context, rather then a dynamic functional understanding that both disambiguates and provides all directives and parameters necessary to translate ‘how’ to compose and execute a matching structured query on a target search facility and ‘where’ to find and link the relevant data structure to the search criteria form.

The subject matter claimed herein is not limited to embodiments that solve any disadvantages or that operate only in environments such as those described above. Rather, this background is only provided to illustrate one exemplary technology area where some embodiments described herein may be practice.

### SUMMARY OF INVENTION

One aspect of the present invention provides a method of obtaining a structured query from a search string. This method enables user input of a query in the form of natural language.

The term “natural language” may be any form of human-understandable expression. For example, where a user wishes to search for houses with prices less than $400,000 and having a swimming pool, the query inputted by the user may read “house under 400 k +pool” (free-text form), “hz<400 large dip” (garbled/abbreviated/slang form), or “kuca iznad . . . ” (alternative language form).

However, application of the method should not be interpreted as being limited to such. It will become apparent that the method is suitable for use in the contexts of generic semantic search or as a translation engine for obtaining structured queries for the purpose of precise data retrieval even in the absence of a search criteria form, as long as the underlying facilities (e.g., search engines and databases) for implementing these functions supports structured queries. The method may comprise: obtaining a functional representation from a parametric representation of the search string according to a functional query index; and obtaining a structured query from the functional representation according to a structured query profile.

The method preferably further comprises populating a search criteria form according to the obtained structured query. It is worth noting that, although the structured query may serve as a basis for population of the search criteria form, its application is not limited to such. Depending on applications, the structured query may, for example, be stored, outputted or further processed. Accordingly, in one embodiment, the method may further comprise the step of adapting the structured query into a search query compliant with a search facility (e.g., a search index or a database) for obtainment of a search result, which may be presented in association with the search criteria form.

The method may further comprise selecting from a relevance index a relevance model representative of a set of rules for determining relevance of the search result. Where the search result consists of a plurality of entries, the data entries may be sorted for presentation according to the rules. In an exemplary scenario where the rules are such that a higher relevance value is to be assigned to the criterion of “location”, entries in the search result corresponding to closer location proximities may be prioritised for presentation.

The structured query profile may be representative of a relationship among functional entities of the functional representation. More particularly, the structured query profile may be descriptive of a relationship for obtaining the structured query from the functional entities. An example of such a relationship may be that a functional entity of a first type is to be related to a functional entity of a second type by a logical operator, such as “AND” or “OR”. Another example of such a relationship may be that entities of the same type are to be independently related to one another by such a logical operator. The rules that select the entity types and hence how they are injected into the structured query profile can be based on any attribute of the parametric or functional entity whether stored in functional index, derived at runtime or provided with the search form. Accordingly, where an exemplary functional representation consists of five functional entities, the corresponding structured query may take the form of: FIND “functional entity 1 AND (functional entity 3 OR functional entity 4) AND (functional entity 2 OR functional entity 5)”. It should be noted that implementation of the structured query profile is not limited these examples.

It is worth noting that the structured query profile may further define a relationship for obtaining the structured query from other types of entities (e.g., text entities) in addition to the functional entities. The text entities may be ones that do not correspond to the relationship defined by the functional query index.

It should be appreciated that not all functional entities are associated with respective parameters. For example, the parametric representation of “by recency” may correspond to the functional entity of “sortByCreatedDate( )” (without a parameter). For comparison, the parametric representation of “under #num#” may correspond to the functional entity of “property.price<#num#”, where “#num#” is a parameter value.

Since the result of population of the search criteria form may be inaccurate (i.e., not reflective of the user's intention), the method may further comprise the step of ascertaining a semantic meaning of the search string according to a change in state of the structured query and a change in state of the search criteria form. More particularly, the method may comprise comparing a difference between a current state and a past state of the structured query with a corresponding difference between a current state and a past state of the search criteria form to thereby ascertain the semantic meaning of the search string. Thus, where a result of form population is inaccurate, a user may make corrective changes to the search criteria form, which gives rise to a corresponding change in the state of the structured query. Accordingly, through comparing the difference between the states of the structured query with that between the states of the search criteria form, the semantic meaning of the search string intended by the user may be ascertained.

It may also be mentioned that the search criteria form is populated from a structured query according to a binding method where any or all individual functional entities from which the structured query is obtained are bound and related to form elements of the search criteria form through attributes of the entities. It is therefore evident that optionally once a user interacts with the search criteria they also manually create or modify the functional entities (from the structured query) and send them to the system directly along with the initial search string, which could indicate to override any default or past semantic meaning interpretation. This makes it possible to differentiate that the change in criteria came about by subsequent user intervention and not just default semantic translation of the raw string.

It should be noted that in alternative configurations where each state of the search criteria form corresponds to a respective structured query, the method may comprise the step of comparing a difference between a current structured query and a past structured query with a corresponding difference between a current state and a past state of the search criteria form to thereby ascertain the semantic meaning of the search string.

The ascertained semantic meaning may provide a basis for improving accuracies of further search results and, where applicable, for ascertaining a meaning of a portion of the search string (e.g. a new word) that does not correspond to any entry in the functional query index. The method may further comprise updating the functional query index according to the ascertained semantic meaning of the search string. The method may further comprise updating the relevance index according to the ascertained semantic meaning of the search string. The method may further comprise updating the structured query profile according to the ascertained semantic meaning of the search string. In other words, the method may further comprise updating the indices and the profile such that the indices and the profile are reflective of the ascertained meaning of the portion of the search string. Where a meaning of a new word is thus ascertained and where the indices and the profile are updated accordingly, the same word in a further search string will form part of the parametric representation and a corresponding entry will be found in the functional query index, and, preferably, in the relevance index and the structured query profile.

In one arrangement, the parametric representation comprises at least one parametric entity; the functional representation comprises at least one functional entity; and the functional query index comprises an entry representative of a relationship between said at least one parametric entity and the at least one functional entity.

Each functional entity may indicate at least one function. For example, in the context of real estate services, a parametric representation of “under #num#” may represent two parametric entities of “under” and “#num#”, and may correspond to a functional entity of “property.price<#num#”. Further, a parametric representation of “near ${suburb.name}” may represent two parametric entities of “near” and “${suburb.name}”, and may correspond to functional entities of “property.lat/lon<${suburb.lat/lon}+3km” and “property.lat/lon>${suburb.lat/lon}−3km”.

Where the search string is not compatible with the functional query index, the method may further comprise, prior to obtaining the functional representation, adapting the search string for compliance with the functional query index. Where the search string is not associated with a parametric representation, the method may further comprise, prior to obtaining the functional representation, parsing the search string to obtain the parametric representation. Where the parametric representation is not compatible with the functional query index, the method may further comprise, prior to obtaining the functional representation, adapting the parametric representation for compliance with the functional query index.

In the exemplary context of real estate services, the search facility may be a database with entries of properties, and the search criteria form may consists of a plurality of form elements (e.g., drop-down menus, input fields and checkboxes) corresponding respectively to various search criteria such as price, property type and amenities. It will be apparent that the method is also applicable to any search facility that operates on such a database where the structure of the data lends itself to precise search criteria functions on discreet attributes whether or not these are associated with search criteria forms in the user interface, or visually represented with alternative embodiments. It will be apparent that the method is also is applicable to search facilities in other contexts. Such other contexts may include, consumer-to-consumer sales services, media and content publishing services, compliance and auditing applications, knowledge graph search and other search-centric applications.

The search facility may also take other suitable forms, such as an application associated with a number of search filters for input of search criteria in relation to a database, a catalogue, or the like, where the purpose may be to retrieve some or all of the data, and the output may be a summary, a report, a visual representation, a transformation, a streaming endpoint, or only the translated structured query executable on another local or remote system.

It is envisaged that the user interaction module may be configured to store, for each user, different states of the structured query and respective states of the search criteria form 41 in relation to a unique profile corresponding to the user. This arrangement is useful for providing customised user experiences for multiple users.

Another aspect of the present invention is to provide a system for obtaining a structured query from a search string. In one embodiment, the system is configured to perform the abovementioned method, and may adopt any of the abovementioned alternative or optional arrangements of the method where applicable.

The system may comprise: a functional query module configured to obtain a functional representation from a parametric representation of the search string a functional representation according to a functional query index; and a relevance module configured to obtain a structured query from the functional representation according to a structured query profile; whereby population of the search criteria form according to the obtained structured query is enabled.

The system may further comprise a query adaption module configured to populate a search criteria form according to the obtained structured query. The system may further comprise a query adaption module configured to adapt the structured query into a search query compliant with a search facility for obtainment of a search result. Where the search facility has specific compliance requirements, the query adaption module is operable to ensure compatibility of the search query with the search facility. The search result may be presented in association with the search criteria form. It should be noted that multiple search facilities could be aggregated and search request federated across these where the structured query may be adapted for compliance using multiple different adaptors.

As suggested above, the relevance module may further be configured to select from a relevance index a relevance model representative of a set of rules for determining relevance of the search result. The rules may serve as a basis for determining each text and functional entity as applied to each search result and a relevance profile for determining the way those individual relevance scores are combined to calculate the total relevance score for each search result. Further, the structured query profile may be representative of a relationship among functional entities of the functional representation.

The system may further comprise a user interaction module configured to ascertain a semantic meaning of the search string according to a change in state of the structured query and a change in state of the search criteria form. The alternative embodiment of the structured query (i.e., the current structured query and the past structured query) described in relation to the method is also applicable to the system. Preferably, the user interaction module is further configured to update the functional query index according to the ascertained semantic meaning of the search string. Preferably, the user interaction module is further configured to update the relevance index according to the ascertained semantic meaning of the search string. Preferably, the user interaction module is further configured to update the structured query profile according to the ascertained semantic meaning of the search string

It is understood that in embodiments without the user interaction module, the system may still serve to ascertain semantic meaning of search strings and improve accuracy of the search results. This can be achieved because the system may be manually configured by an administrator with semantic associations between parametric representations and functional entities, thereby defining a semantic translation layer for converting the free-text search string into advanced and precise structured queries. The search accuracy is improved by using structured queries instead of search strings directly on all text because they operate as functions on discrete data dimensions and as such are more precise and descriptive for data retrieval. The sets of semantic associations can form “functional dictionaries” that can be packaged with the system by default and define specific search taxonomy for industry or domain specific language translations.

As described above, in one configuration, the parametric representation comprises at least one parametric entity; the functional representation comprises at least one functional entity; and the functional query index comprises an entry representative of a relationship between the at least one parametric entity and the at least one functional entity.

In applications where the search string received by the system is not associated with a parametric representation, the system may further comprise a parameterisation module configured to parse the search string to obtain the parametric representation. The parameterisation module may preferably be further configured to adapt the parametric representation for compliance with the functional query index. Alternatively, where the search string received by the system is associated with a parametric representation incompatible with the functional query index, the system may further comprise a parameterisation module configured to adapt the parametric representation for compliance with the functional query index.

Another aspect of the present invention is to provide a computer-readable medium for enabling population of a search criteria form from a search string. The computer-readable medium comprises instruction for performing the abovementioned method. The alternative arrangements of the above method and system are also applicable to the computer-readable medium, and will not be repeated below for the sake of brevity.

It is apparent from the above that embodiments of the method, system, and computer-readable medium of the present invention may be capable of:
1. dynamically composing structured queries from arbitrary search strings; This serves effectively as a generic method of defining an automated translation engine from any free text into any other type of advanced and precise structured query syntax, language or instructions.
2. based on the presence and absence of only free text terms and phrases, dynamically choose the template of the overall structure for the composition of an advanced query, as well as choosing the individual functional entities (sub-queries) that it is composed of, as well as dynamically choosing the specific relevance models which are to be applied to compute a score for each of the functional entities (sub-queries) as well as choosing the overall relevance model (relevance profile) that is used to blend these into a final score for each search result. Furthermore when user interaction module is enabled the system can dynamically learn and completely change or adjust each of the individual parts of the aforementioned dynamically chosen elements for the purpose of diverging the translation semantics towards actual user behaviour.
3. learn user behaviour and adapt the system understanding of how to precisely translate arbitrary or user specific free text into a specific structured query of a specific target language syntax as required to interface with a range of search facilities;
4. allows the user to use the same free text queries across any number of search facilities because the translations from free text to structured queries occurs generically and as such is easily portable. The system can be extended to support another data source by simply creating a new search facility adapter; the user can then port the exact same search experience to any or all compatible websites they visit for example. (e.g. The user could save and download their semantic configuration and upload it to another compatible website, or this could be done automatically on the users behalf, which would mean that given “und $400” means where price is under $400 for that user on ebay, it will mean the same thing on amazon, etc.)
5. enabling a user to search for and to filter precisely, whether in the embodiment of dynamically or automatically generating search criteria filters and presenting to the user or not, on any dimension of the data structure without the user understanding the structure of the underlying data, the filters that are available, or a system developer having to manually implement these filters as search criteria. (i.e. If the structure of the underlying database is changed, users can suddenly and immediately search more precisely on the added dimension without intervention from system developers or changes to the search user and facility interface)

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF ACCOMPANYING DRAWINGS

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates a block diagram of a preferred embodiment of a system for enabling population of a search criteria form from a search string, according to the present invention.

FIG. 2 illustrates a flowchart of a preferred embodiment of a method of enabling population of a search criteria form from a search string, according to the present invention.

FIG. 3 illustrates one state of a search criteria form of an exemplary website interface.

FIG. 4 illustrates another state of the search criteria form of FIG. 3.

FIG. 5 illustrates one state of a search criteria form of another exemplary website interface.

FIG. 6 illustrates another state of the search criteria form of FIG. 5.

### DETAILED DESCRIPTION OF THE PREFERRED EMBODIMENTS

Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

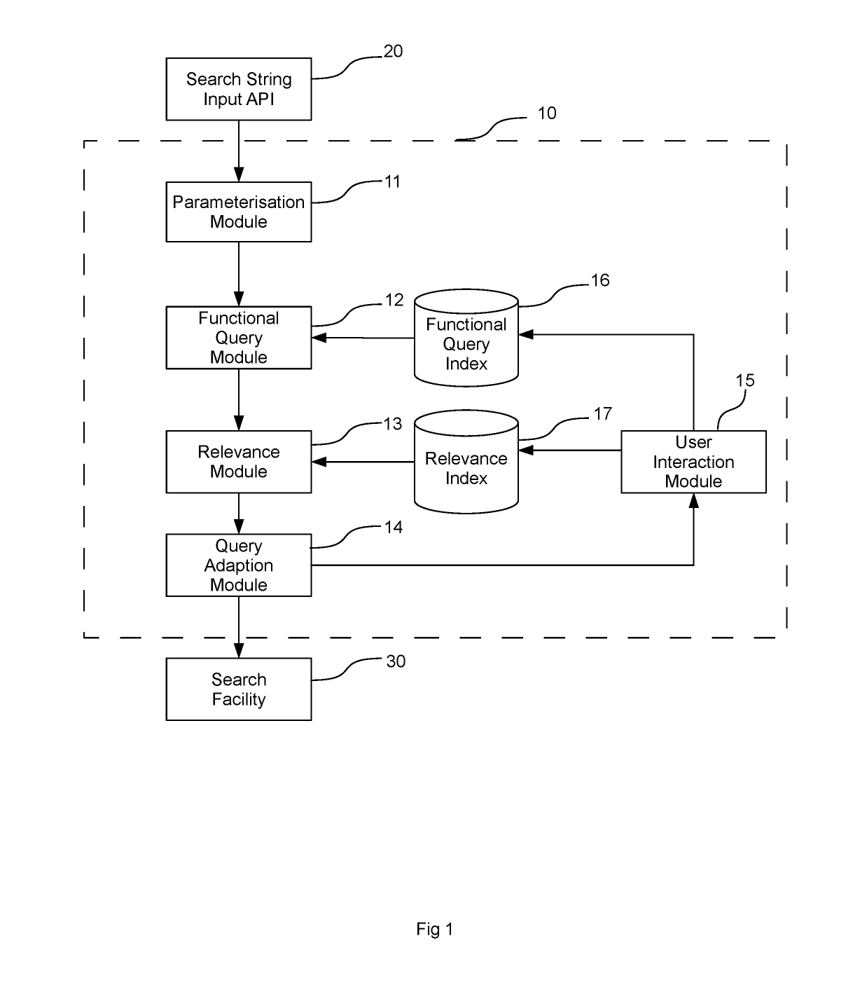

Referring to FIG. 1, the system 10 of a preferred embodiment according to the present invention includes a parameterisation module 11 operatively associated with a search string input application programming interface (API) 20, a functional query module 12 operatively associated with the parameterisation module 11, a relevance module 13 operatively associated with the functional query module 12, a query adaption module 14 operatively associated with the relevance module 13 and a search facility 30, a user interaction module 15 operatively associated with the query adaption module 14, a functional query index 16 operatively associated with the user interaction module 15 and the functional query module 12, and a relevance index 17 operatively associated with the user interaction module 15 and the relevance module 13.

The search string input API 20 is adapted to provide a search string in response to an input string. The input string is a query in the form of natural language text provided by a user. In the preferred embodiment, the search string is identical to the input string. Hereafter, we will make reference to an exemplary input string reading “renovated house under 500 k near toorak by price”. In other embodiments, the search string may be different from the input string.

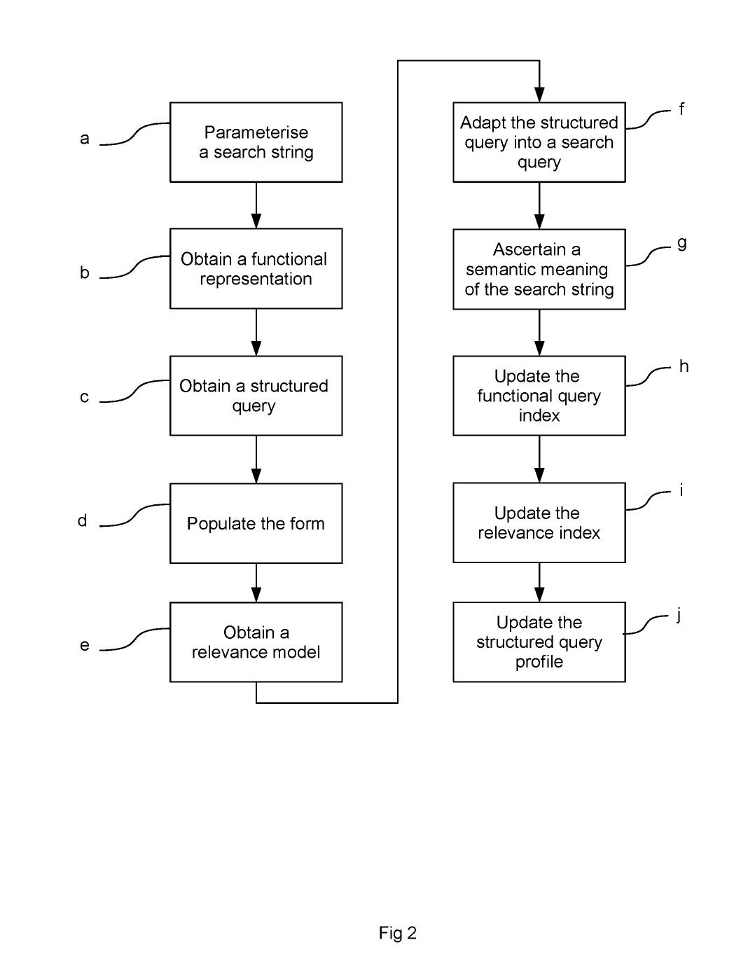

Shown in FIG. 2 are steps of the method performed by the system 10.

In step a), the parameterisation module 11 is configured to parameterise the search string. Parameterisation of the search string by the parameterisation module 11 includes adapting the search string for compliance with the functional query index 16, and further parsing the adapted search string to obtain a parametric representation of the adapted search string.

In the exemplary embodiment, the adapted search string reads “renovated house under #num# near Toorak by ${suburb.name}”, and the parametric representation includes eight parametric entities: “renovated”, “house”, “under”, “#num#=500000”, “near”, “${suburb.name}=Toorak”, “by” and “price”, where “#num” and “${suburb}” are parameters with respective values of “500000” and “Toorak” where extended parametric information was obtained.

The parameterisation module 11 may be configured in another alternative arrangement such that the parametric representation may include only two parametric entities: “#num#=500000”, and “${suburb}=Toorak”.

It is worth noting that parameterisation module may determine and attach any other contextual attributes to the parametric entities that can be used by the functional index lookup or elsewhere throughout the method including but not limited to the position or offset of the parameter within the raw query, the suggested type of the parameter (date, num, distance num like kms, entity, boolean, etc.), the classification or completeness of the parameter (date, time, date+time, distance number in kms, mass measurement in pounds, etc.).

It is also worth noting that where the search string received by the parameterisation module 11 is already compliant with the functional query index 16, the step of adapting the search string for compliance may be omitted. Further, in another embodiment where the search string received by the system 10 is already associated with a parametric representation with parametric entities compliant with the functional query index, the parameterisation module 11 may be omitted.

In step b), the functional query module 12 is configured to obtain a functional representation from the parametric representation according to the functional query index 16. The functional query index 16 comprises a plurality of entries, each of which is representative of a relationship between at least one parametric entity and at least one functional entity.

Shown in Table 1 is a tabular representation of entries of the functional query index 16 relevant to the exemplary embodiment.

TABLE 1

| Parametric | |
|---|---|
| entity(ies) | Functional entity(ies) |
| House | property.type=“house” |
| under #num# | property.price<#num# |
| near ${suburb.name} | property.lat/lon<${suburb.lat/lon} + 3 km AND |
| | property.lat/lon>${suburb.lat/lon} − 3 km |
| by price | sort by property.price |

Accordingly, with the eight parametric entities, the functional representation in this scenario includes five functional entities: property.type=“house”, property.price<500000, property.lat/lon<14.234, property.lat/lon>13.582, and sort by property.price. The values of “14.234” and “13.582” are calculated based on a global positioning system (GPS) coordinates corresponding to the suburb “Toorak” according to a predetermined coordinate calculation technique. However, obtainment of such values may be otherwise implemented in other embodiments.

It is to be noted that since the functional query index 16 lacks an entry for “renovated”, this word will be treated and processed as a text entity (i.e., non-functional) in the context of the current search.

The following is a table showing non-limiting examples of formats of the functional query index. Depending on application, more attributes may be stored as required to interpret semantic instructions correctly. It is apparent in the descriptions of the index fields and corresponding descriptions how the functional index can be used to translate free-text to semantic instructions.

| Field | Description | Example |
|---|---|---|
| Phrase | The free-text phrase | “under” #num#” |
| | that when matched | |
| | should select this | |
| | semantic instruction. | |
| | The phrase is | |
| | composed of a mixture | |
| | of any text entities | |
| | (“under”) and parametric | |
| | entities (“#num#, | |
| | #date#, ${suburb}, etc.) | |
| Functional Entities | The functional entities | lessThenPrice(#num#) = |
| (Sub-query) | (sub-query) that should | function(#num#) { |
| | be executed when the | price < (#num# + $100) |
| | Phrase is matched. The | } |
| | function entities | |
| | specified could | |
| | reference a predefined | |
| | list of functions available | |
| | in the system or have | |
| | custom function | |
| | definitions and | |
| | implementation scripts | |
| | provided at | |
| | configuration time by | |
| | administrator. | |
| Group | The functional entity | “pricing-filters” |
| | group that this semantic | |
| | belongs to and | |
| | activates. Groups are | |
| | important for functional | |
| | entities to be associated | |
| | and bound to filters in | |
| | the search criteria form | |
| | and placements in the | |
| | structured query | |
| | profiles. | |
| Partition | Any data partitions that | realestate.properties |
| | this semantic is | |
| | restricted to, e.g. May | |
| | be restricted to a | |
| | particular | |
| | dataset/database or | |
| | table within a database, | |
| | or by country/region, | |
| | etc. | |
| User | Any user or role that this | nino.svonja or * |
| | semantic is restricted to | |
| Terms | The individual tokenised | “under”, “#num#” |
| | terms of the phrase | |
| Params | A list of the individual | A list of structured |
| | parameters and their | objects describing the |
| | attributes as required for | params.. |
| | this function | |
| Label | The optional default | “Min Price” |
| | description label that | |
| | this semantic should be | |
| | described or populated | |
| | as. | |
| Matching Criteria | One or more matching | An structured object |
| | criteria that describe | containing the criteria |
| | how this phrase can be | |
| | found given the original | |
| | raw query. | |
| | E.g. Must match a | |
| | minimum number of | |
| | terms from the phrase in | |
| | the raw query | |
| | E.g. Must also contain | |
| | another phrase, type or | |
| | group, etc. | |
| | E.g. Must match a | |
| | minimum number of | |
| | params | |
| | E.g. Whether the order | |
| | of terms must be | |
| | preserved | |
| | E.g. Max distance | |
| | between phrase terms | |
| | in the raw query | |
| | Etc. | |

In step c), the relevance module 13 is configured to obtain a structured query from the functional representation according to structured query profile (not shown) representative of a relationship among the functional entities and the text entity. In the exemplary embodiment, the structured query profile defines only “AND” operators among the functional entities and the text entity. Shown below is a representation of the structured query:

### FIND

_all_text like “renovated”

### AND

property.type=“house”

### AND

property.price<500000

### AND

property.lat/lon<14.234

### AND

property.lat/lon>13.582

### AND

sort by property.price

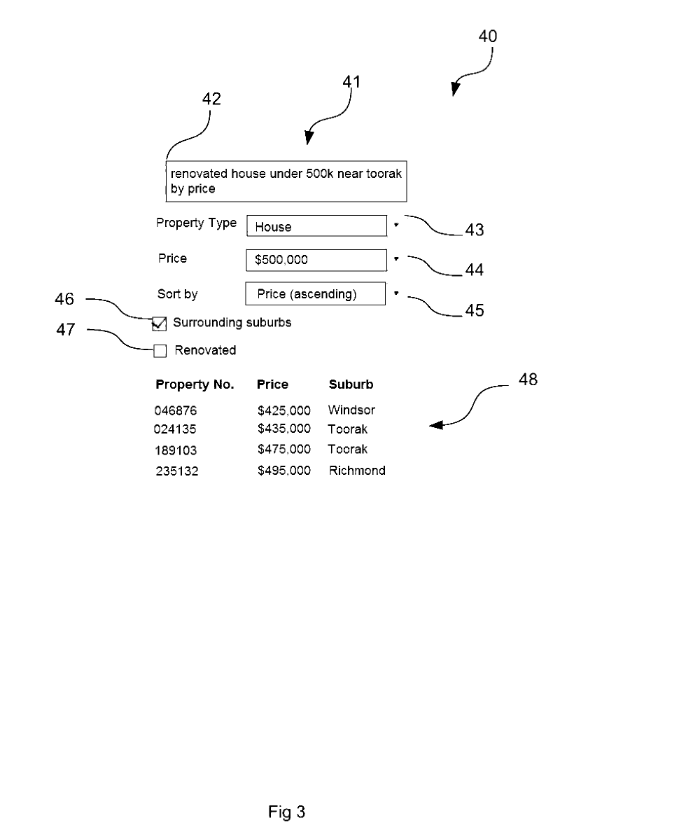

Shown in FIG. 3 is an exemplary website interface 40 including a search criteria form 41 that includes a text input field 42 for user input of the input string, a drop-down menu 43 for selection of property type, a drop-down menu 44 for selection of price, a drop-down menu 45 for specification of a sorting rule, a checkbox 46 for inclusion of properties in geographical proximity, and a checkbox 47 for inclusion of renovated properties. The interface 40 further includes a result display region 48 for display of a search result.

In step d), the system 10 is configured to populate the search criteria form according to the structured query thus obtained. More particularly, the drop-down menus 43-45 and the check boxes 46, 47 are populated according to the input string in the text input field 42.

In step e), the relevance module 13 is configured to select from the relevance index 17 a relevance model representative of a set of rules for determining relevance of a search result to be obtained based on a search query corresponding to the structured query. Specifically, the relevance index 17 comprises a plurality of entries, each of which corresponds to a respective type of application and each of which defines a method to calculate a relevance value for each of the functional entities and the text entity. In the exemplary embodiment, there are three relevance models selected by the relevance module 13 corresponding to a low-to-high value based sort model associated with the “sort by property.price” functional entity that operates on the price field value, as well as two standard vector space term relevance models for the “renovated” and “house” text and functional entities. The relevance score from each relevance model is then combined in accordance with a selected relevance profile so that a total score is calculated for each matching result as a blend between the three scores calculated by the individual relevance models. The low-to-high value based sort model uses the price value of each matching real estate property as the base for a score and then inverts it so that a lower price value results in a higher relevance score. In other words, the effect of the selected relevance model is such that a higher relevance value is to be assigned to cheaper matching real estate properties. The vector space relevance model calculations are well-established standard algorithms and omitted for simplicity. However, in other embodiments, different relevance models may be configured and selected according to the rules resulting in higher relevance values assigned to other such criteria. Furthermore, the relevance profile may blend individual scores evenly to compute the total score, or use another blending strategy, like blending scores weighted by boost factors determined by the strength of applicability of each semantic entity (functional, text, relevance model) as determined by the user interaction module over time, or manually configured by an administrator.

It is envisaged that, in an alternative embodiment, the functional query index 16 may be integrated with the relevance index 17. It is also envisaged that obtainment of the functional entities and that of the relevance model may occur concurrently or in a single operation.

It is worth noting that the relevance module 13 may be configured to select the relevance model and profile according to various factors, such as absence or presence of any other entity (e.g. Presence of “house” text entity may always revert to the real estate service relevance profile), implicit partitioning information whether provided by the user or configured (e.g. User geography, user identity or role, area of website, incoming tracking breadcrumbs, etc.), rules implemented within the relevance model or profile (E.g. if a “strict sort” relevance model is selected implicitly, the relevance profile may excludes and disregards any other matching relevance models and simply revert to a straight sort relevance rather then a blend, E.g. A relevance profile may dictate that if no other sorting or blending relevance models were matched that a default sort by date is applied, E.g. A relevance model associated with a functional entity “near Toorak” which is value based on the distance from a target suburb may dictate that if another amplifying text entity like “very” is selected the score is boosted or an exponential curve is used instead of linear for mapping result values that in effect amplifies relevance of properties “very near Toorak”), and any other obvious dynamic behaviour based on any attributes configured on any of the entities, models and profiles.

In step f), the query adaption module 14 is configured to adapt the structured query into a search query compliant with the search facility for obtainment of the search result. The search facility 30 is, in the exemplary embodiment, configured to perform a search according to the search query provided by the query adaption module 14. However, in embodiments where the search facility is compliant with the structured query or is capable of adaption for compliance, step f) and hence the query adaption module 14 may be omitted and the search facility 30 may perform the search according to the structured query.

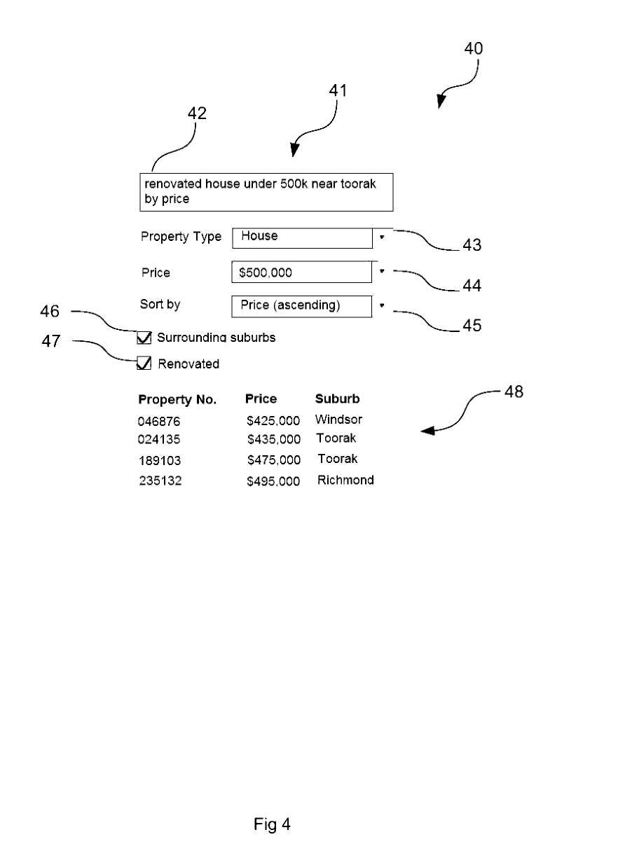

In the scenario shown in FIG. 3, the search result comprises a plurality of entries of real estate properties, which are sorted in an ascending order of price for display in the result display region 48. In the exemplary embodiment, since the user intends to limit the search to real estate properties that are renovated, the user accordingly checks the checkbox 47 (see FIG. 4), which causes a change in state of the structured query and a corresponding change in state of the search criteria form 41.

In step g), the user interaction module 15 is configured to ascertain a semantic meaning of the search string. Specifically, the user interaction module 15 is configured to compare the change in state of the search criteria form 41 and the change in state of the structured query so as to ascertain the semantic meaning.

The user interaction module 15 of the exemplary embodiment is operatively associated with an interaction history index (not shown) for storage (e.g., recording) of different states of the structured query and respective states of the search criteria form 41 therein.

The following is an example format of the interaction history index, but more fields may be stored as required to improve interaction detection. It is apparent in the descriptions of the index fields and corresponding descriptions how the interaction history index can be used to track user interaction and ascertain semantic meaning from unspecified free-text.

| Field | Description | Example |
|---|---|---|
| Raw Query | The raw query | “luxury house in toorak” |
| Structured Query | The full structured query | { |
| | that was created via the | Text: “luxury” |
| | semantic translation | Property.type: “house” |
| | process described | Property.suburb: |
| | above. | “Toorak” |
| | | Property.price > 1 m |
| | | . . . |
| | | } |
| Semantic | List of detected | “house” → type = House |
| Instructions | semantic instructions in | “in Toorak” → |
| | the form of functional | suburb = Toorak |
| | entities sourced from | |
| | the functional index. | |
| Semantic | A delta in the list of | property.price > 1 m |
| Instructions | semantic instructions | |
| Delta | that were detected | |
| | between this and the | |
| | last search request. | |
| Unmatched Text | List of text entities | “luxury” |
| Entities | (terms or phrases) that | |
| | did not match any | |
| | semantics | |
| Unmatched Text | A delta in the list of text | “luxury” |
| Entities Delta | entities (terms or | |
| | phrases) that did not | |
| | match any semantics | |
| | between this and the | |
| | last search request | |
| Time | The search request | |
| | timestamp. | |
| User | The search request user | |
| Partition | Any partition information | |
| | about the query. (E.g. | |
| | Geo-Location, etc.) | |
| SessionId | The session identifier of | |
| | the search request | |
| InteractionId | The interaction identifier | |
| | of the search request— | |
| | used to suggest when a | |
| | search request is part of | |
| | an interaction chain to | |
| | find a specific result set. | |

It is to be noted that, in an alternative embodiment where each state of the search criteria form 41 corresponds to a respective structured query, the user interaction module 15 may be configured to ascertain the semantic meaning by comparing the states of the search criteria form 41 and a corresponding difference between the respective structured queries.

Based on a result of the comparison, the user interaction module 15 is operable in the present embodiment to identify a correspondence relationship between the text entity “renovated” and the checkbox 47

In step h), the user interaction module 15 is configured to update the functional query index 16 according to the ascertained semantic meaning, more particularly to the identified correspondence relationship. In particular, the semantic interaction module 15 is configured to create an entry in the functional query index 16 corresponding to the identified correspondence relationship (see the lowermost entry in Table 2).

TABLE 2

| Parametric | |
|---|---|
| entity(ies) | Functional entity(ies) |
| house | property.type = “house” |
| Under #num# | property.price<#num# |
| Near ${suburb.name} | property.lat/lon<${suburb.lat/lon} + 3 km AND |
| | property.lat/lon>${suburb.lat/lon} − 3 km |
| by price | sort by property.price |
| renovated | property.condition = “3” |

It should be noted that the functional query index 16 and the relevance index 17 may also be otherwise configured by, for example, a system administrator for addition, modification and deletion of contents. This configuration is particularly useful in embodiments without the user interaction module 15.

With the updated semantic query index 16, a further search string containing the word “renovated” will result in a parametric entity of “renovated” and a corresponding functional entity of “property.condition=3”, which will, in turn, result in checking of the checkbox 47. For example, a property.condition with values of “0”, “1”, “2” and “3” may represent conditions of “new”, “established”, “off-plan” and “renovated”, respectively.

In steps i) and j), the semantic interaction module 15 is configured to update the relevance index and the structured query profile, respectively, according to the identified correspondence relationship. Depending on implementation, the relevance model may in one embodiment take the form of a vector space model containing a plurality of terms, each of which may initially and independently be associated with a weight value of 25% of a predetermined maximum weight value. The weight value is to be adjusted by the semantic interaction module 15 according to the ascertained semantic meaning.

In addition to ascertaining a meaning of a text entity, the semantic interaction module 15 is also capable of updating an existing correspondence relationship between at least one parametric entity and at least one functional entity according to the ascertained semantic meaning.

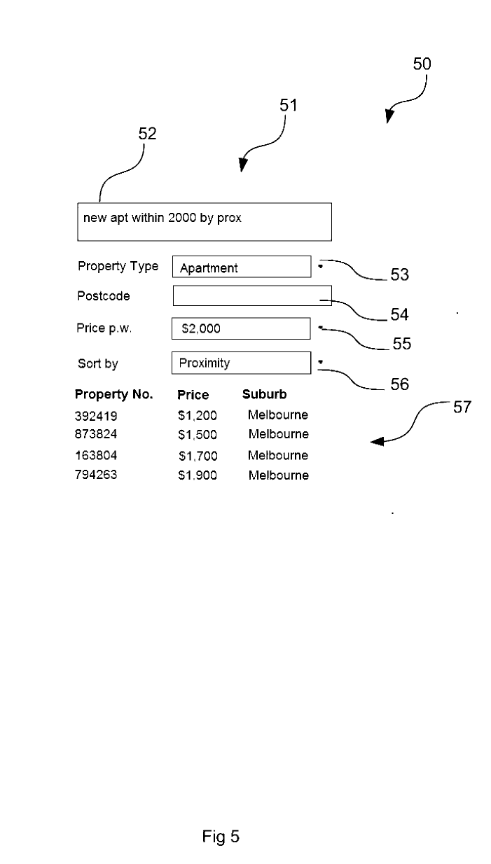

Shown in FIG. 5 is an exemplary website interface 50 in another scenario, in which a user wishes to search for new apartments having a postcode of “2000” and have the search result sorted according to geographical proximity.

The website interface 50 in this embodiment includes a search criteria form 51 that includes a text input field 52 for user input of an input string, a drop-down menu 53 for selection of property type, an input field for input of a postcode 54, a drop-down menu 55 for selection of a weekly price, and a drop-down menu 56 for specification of a sorting rule. The website interface 50 further includes a result display region 57 for display of a search result.

The search string input API 20 is operable to provide a search string of “new apt within 2000 by prox” in response to input of an input string in the text input field 52 by the user.

In step a), the parameterisation module 11 is configured to adapt the search string into “new apt within #num# by prox” and to obtain a parametric representation containing parametric entities of “new”, “apt”, “within”, “#num#” (where #num# is a numeric parameter with a value of “2000”), “by”, and “prox”.

In step b), the functional query module 12 is configured to obtain a functional representation containing functional entities of “property.condition.‘new’”, “property.type=‘apartment’”, “property.price<#num#”, and “sort by proximityTo(property.location)” according to the functional query index 16. Shown in Table 3 are relevant entries in the functional query index 16 in the embodiment of FIG. 5.

TABLE 3

| Parametric | |
|---|---|
| entity(ies) | Functional entity(ies) |
| new | property.condition = “new” |
| apt | property.type = “apartment” |
| within #num# | property.price<#num# |
| by prox | sort by proximityTo(property.location) |

In step c), the relevance module 17 is configured to obtain a structured query according to the functional entities based on an exemplary structured query profile defining only “AND”. Shown below is a representation of the structured query:

### FIND

property.condition=“new”

### AND

property.type=“apartment”

### AND

property. price<2000

### AND

sort by property.proximity

In step d), the system 10 is configured to populate the search criteria form 51, as shown in FIG. 5.

In step e), the relevance module 13 is configured to obtain a relevance model.

In step f), the query adaption module 14 is configured to adapt the structured query into a search query compliant with the search facility 30 for obtainment of a search result, which is shown in the result display region 57.

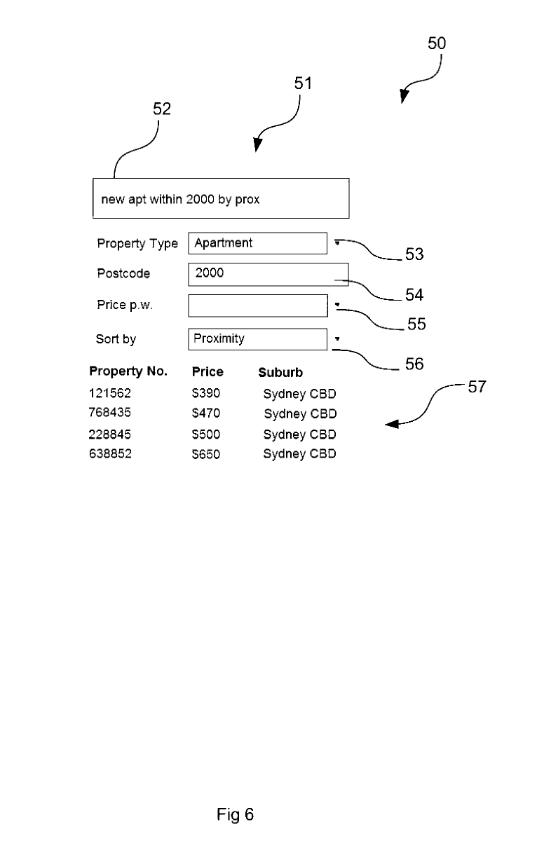

Because the value “2000” is shown to be improperly associated with the drop-down menu 55 (i.e., weekly price), the user then configures the search criteria form 51 such that the value is associated with the input field 54 (i.e., postcode) and the drop-down menu 55 is left blank, as shown in FIG. 6. The configuration of the search criteria form 51 gives rise to a change in state of the structured query and a corresponding change in the search criteria form 51.

In step g), the user interaction module 15 is configured to compare the change in state of the search criteria form 51 and the change in state of the structured query so as to ascertain the semantic meaning of the search string. In the current scenario, a result of the comparison indicates that the user intends to refer to the postcode, not the price, by the value “2000”. In steps h) to j), the user interaction module 15 is configured to update the functional query index 16, the relevance index 17, and the structured query profile (not shown) according to the result of the comparison, respectively. Table 4 shows a tabular representation of relevant entries in the updated functional query index 16, where the parametric representation “within #num#” now corresponds to the functional entity “property.postcode<#num#” as opposed to “property.price<#num#” (see Table 3).

TABLE 4

| Parametric | |
|---|---|
| entity(ies) | Functional entity(ies) |
| new | property.condition = “new” |
| apt | property.type = “apartment” |
| within #num# | property.postcode<#num# |
| by prox | sort by proximityTo(property.location) |

Accordingly, in a subsequent search where the search string input API 20 provides a search string of “new apt within 3000 by prox”, the input field 54 (i.e., postcode) instead of the drop-down menu 55 (i.e., weekly price) will be populated with the value of “3000”.

In a practical scenario involving multiple users, the user interaction module 15 may be configured to store in the interaction history index, for each user, different states of the structured query and respective states of the search criteria form 41 in relation to a unique profile corresponding to the user. This arrangement is capable of providing a customised user experience for each of multiple users. In embodiments involving multiple users, each of the functional query index 16 and the relevance index 17 may be further configured such that each entry in the functional query index 16 and the relevance index 17 is associated with a corresponding user.

Table 5 shows exemplary entries of the functional query index 16 in an embodiment involving multiple users. In the example of Table 5, the functional query index 16 contains two entries respectively defining different relationships between parametric representation and functional entity for different users. In the embodiment of Table 5, inclusion of the phrase “within 2000” in a search query associated with user “001” would result in a functional entity of “property.price<2000”, whereas inclusion of the phrase “within 2000” in a search query associated with user “002” would result in a functional entity of “property.postcode=2000”. As alluded to above, such relationships may be changed by the user interaction module 15 according to a result of ascertainment of a semantic meaning of the search string.

TABLE 5

| Parametric | | |
|---|---|---|
| entity(ies) | Functional entity(ies) | User |
| Within #num# | property.price<#num# | 001 |
| Within #num# | property.postcode = #num# | 002 |

In an alternative embodiment, the user interaction module 15 may be further configured to update the functional query index, the relevance index, and the structured query profile according to a set of update rules.

It is worth noting that, although the steps in the present embodiment are shown to be performed in sequence, the steps may be performed in other orders where applicable in other embodiments. Further, some steps may be performed concurrently. For example, steps e) may be performed concurrently with or before step d), so may steps i) and j) with respect to step h). Steps h), i) and j) may be performed in any arbitrary order after step g). Steps g) to j) may be optional. Depending on configuration, step a) may be optional.

Existing search facilities may use a score to rank each matching document and retrieve them in a sorted descending score order. Typically, this score is calculated by combining the individually calculated scores for each text term using well know IR relevance ranking algorithms (relevance models like vector space or BM25) so as to quantify the relevance of the presence of each term from the raw query in context of all and the matching document space. It is apparent that the same method cannot be used for calculating the score of structured queries, which are composed of functional entities alongside text entities for which the above algorithms will not immediately apply, in lieu of which typical search facilities may assign constant scores to structured queries and loose the context of relevance among retrieved results. It is the purpose of the relevance engine to overcome this deficiency by approximating the score of functional entities as if they were text entities and calculate a relevance score for these in a generic way so as to mimic traditional well established text IR relevance models, having these scores may allow the relevance engine to rank each document accurately even when matched by a mixed structured query.

This capability is made possible by two stages of computation: firstly each functional entity may be associated with a relevance model either implicitly or through the relevance index. The purpose of the relevance model is to provide a quantifiable value that represents the output of the functional entity when applied to the search result and possibly inverted so that higher values denote better relevance as per search facility ranking conventions. The table bellow shows how the relevance models may calculate the score for the raw query “renovated house under 500000 near Toorak by price”.

| Entity | Description | Example |
|---|---|---|
| “renovated” | Text Parametric Entity. Uses well | House#1 = 4.5 |
| | established vector space IR | House#2 = 4.4 |
| | relevance model | House#3 = 4.1 |
| | | (Note: For clarity the IR |
| | | calculation has been |
| | | omitted) |
| “house” | Text Parametric Entity. Uses well | House#1 = 3.4 |
| | established vector space IR | House#2 = 3.6 |
| | relevance model | House#3 = 3.3 |
| | | (Note: For clarity the IR |
| | | calculation has been |
| | | omitted) |
| “under | Functional Entity. Acts only as a | House#1-3 = 0 |
| 500000” | filter in this example with no | |
| | associated relevance model and | |
| | hence no inclusion in combined | |
| | score | |
| “near | Functional Entity. May use a | House#1, 0.2 kms = −0.2 |
| Toorak” | low-high value distance based | House#2, 0.8 kms = −0.8 |
| | relevance model where the score | House#3, 0.3 kms = −0.3 |
| | is the inverted difference between | |
| | the provided and the result values | (Note: For clarity the |
| | lat/lon GPS coordinates to denote | distance calculation |
| | that houses closer to the centre of | based on lat/lon has |
| | Toorak have a higher score. | been omitted) |
| “by price” | Functional Entity. May use a | House#1, $450,000 = |
| | low-high value based relevance | −450,000 |
| | model where the score is the | House#2, $460,000 = |
| | inverted value of price to denote | −460,000 |
| | that cheaper houses have a higher | House#3, 250,000 = |
| | score. | −250,000 |

The second stage involves normalising and combining the individual scores from the relevance models into a single result score by using the relevance profile. The normalisation is important to even out the relevance impact of each functional entity relevance rank with the text parametric entities relevance rank. Table below shows how the normalised scores may be calculated.

| Entity | Quantifiable Rank | Normalised Rank | Description |
|---|---|---|---|
| “near | House#1 = −0.2 | House#1 = 4.05 | The ranks are |
| Toorak” | House#2 = −0.8 | House#2 = 3.7 | normalised by |
| | House#3 = −0.3 | House#3 = 3.99 | proportionally |
| | | | mapping them |
| | | | using standard |
| | | | linear |
| | | | tranformations |
| | | | from their current |
| | | | range to the query |
| | | | text entity average |
| | | | rank range |
| | | | calculated in this |
| | | | example as 3.7 to |
| | | | 4.05. |
| “by price” | House#1 = −450000 | House#1 = 4.0325 | Same as above |
| | House#2 = −460000 | House#2 = 3.7 | |
| | House#3 = −250000 | House#3 = 4.05 | |

The query text entity average rank range is found by calculating the average min and average max score of all the search results matching the current query. (e.g. Min=(4.1+3.3)/2, Max=(4.4+3.6)/2) In alternate embodiments other query text entity average rank range calculations can be used like min-min to max-max, or using functional entity field values from entire document space. Furthermore a full suite of curve transformations could be used instead of the linear transformation above to map and normalise the ranks, as well as value distribution histograms curves of the matching result set or entire document space.

The final score is calculated by combining each individual rank for each text and functional entity typically using addition (e.g. House#1: 4.5+3.4+4.05+4.0325=15.98) but may use also other methods and weighted blending where a boost factor (B) is used to control how much of each entity rank makes up the final score (e.g. R1*B1 +R2*B2 . . . ).

It is apparent that the base relevance model and profile may have the following broad flow the implementation of which will vary from model to model and profile to profile:
1. Calculate or get the quantifiable value representative of the functional entity upon the result document. (E.g. House price is $450,000=450,000)
2. or Calculate or get the quantifiable “distance” value from a target representative of the functional entity upon the result document. This is the quantifiable divergence of the actual search result functional entity value from a parametric or other supplied or inherent target value. (E.g. House location is lat/lon 15.534, and target is Toorak with lat/lon 15.535 which may correspond to a distance of 0.001 lat/lon=0.2 kms, full calculation omitted for simplicity)
3. Calculate the rankable score from the quantifiable value by inverting as necessary to create decreasing semantics required by search facility convention. (E.g. House price with lowest price $250 k can be most relevant by having highest rank score −250,000)
4. Calculate the normalised rankable score from the rankable score value by proportionate transformation mapping onto a range calculated to represent the relevance rank range of the text entities part of the structured query.
5. Calculate the total result rank score representing the structured query upon the result document by combining or blending the normalised rankable scores of each text and functional entity according to the relevance profile implementation

It is apparent that by following the relevance model and profile pattern above a range of models and profiles may be developed to represent relevance of functional entites by the value they operate on or produce and calculate relevance of results matched by structured queries by approximate blending of quantifiable functional values.

Referring again to FIGS. 3 to 6, the exemplary website interface 40, 50 in each of these figures may be configured to show the number of form elements 43-47, 53-56 populated by the system 10 according to the search string. In the embodiments of FIGS. 3 to 6, the numbers are “4”, “5”, “3” and “3”, respectively.

Moreover, the website interfaces 40, 50 may also be configured to present tags visually and respectively indicating populated form elements 43-47, 53-56. For example, the website interface 50 in FIG. 4 may present three tags (not shown) labelled “Type”, “Price” and “Sort by”, respectively. The website interface 50 in FIG. 4 may present three tags (not shown) labelled “Type”, “Postcode” and “Sort by”, respectively. The tags may be disposed between the text input field 42 and the drop-down menu 43.

Furthermore, the exemplary website interfaces 40, 50 may be configured such that the form elements 43-47, 53-56 remain hidden until user input of the search string in the text input field 42, 52.

Further exemplary applications of the system 10 are discussed below.

In one scenario where the search string reads “new European car”, the parametric representation may define parametric entities indicating year range (e.g., within 4 years), origin of car, and vehicle type, respectively. However, if another user inputs the same search string, the parametric entity of year range may indicate a different year range (e.g., within 2 years). Based on user manipulation of the search criteria forms 41, 51, the year range indicated by the corresponding parametric entity may change.

In another scenario where a user types in a search string reading “cars within 1 mth”, the term “1 mth” may be interpreted by the system 10 to mean one month. The system 10 may be configured such that, where a parametric entity in time format is preceded by “within”, the system 10 is to generate a structured query that would cause the search facility 30 to return a search result with entries having dates within one month from the time of search. It is envisaged that the user may also user other prepositions and abbreviations, in which case, the system 10 is able to ascertain meanings of these prepositions, abbreviations and the likes in the manner described heretofore.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, all formats and representations of entities are textual and intended only as indication of the data they contain or represent, where in practise they are machine readable object entities with attributes and fields containing any or all required data and are passed through the system in such form that can be utilised by each module as necessary to accomplish the stage of execution.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

It will be appreciated that the foregoing description has been given by way of illustrative example of the invention and that all such modifications and variations thereto as would be apparent to persons of skill in the art are deemed to fall within the broad scope and ambit of the invention as herein set forth.

1. A method of obtaining a structured query from a search string, comprising:
obtaining a functional representation from a parametric representation of the search string according to a functional query index; and
obtaining a structured query from the functional representation according to a structured query profile.

2. The method as claimed in claim 1, further comprising populating a search criteria form according to the obtained structured query.

3. The method as claimed in claim 1, further comprising the step of adapting the structured query into a search query compliant with a search facility for obtainment of a search result.

4. The method as claimed in claim 3, further comprising selecting from a relevance index a relevance model representative of a set of rules for determining relevance of the search result.

5. The method as claimed in claim 1, wherein the structured query profile is representative of a relationship among functional entities of the functional representation.

6. The method as claimed in claim 1, further comprising the step of ascertaining a semantic meaning of the search string according to a change in state of the structured query and a change in state of the search criteria form.

7. The method as claimed in claim 6, further comprising updating the functional query index according to the ascertained semantic meaning of the search string.

8. (canceled)

9. The method as claimed in claim 6, further comprising updating the structured query profile according to the ascertained semantic meaning of the search string.

10. The method as claimed in claim 1, wherein:
the parametric representation comprises at least one parametric entity;
the functional representation comprises at least one functional entity; and
the functional query index comprises an entry representative of a relationship between the at least one parametric entity and the at least one functional entity.

11. The method as claimed in claim 1, further comprising, prior to obtaining the functional representation, the step of parsing the search string to obtain the parametric representation.

12. The method as claimed in claim 1, further comprising, prior to obtaining the functional representation, the step of adapting the parametric representation for compliance with the functional query index.

13. A system for obtaining a structured query from a search string, comprising:
a functional query module configured to obtain a functional representation from a parametric representation of the search string according to a functional query index; and
a relevance module configured to obtain a structured query from the functional representation according to a structured query profile.

14. The system as claimed in claim 13, further comprising a query adaption module configured to populate a search criteria form according to the obtained structured query.

15. The system as claimed in claim 13, further comprising a query adaption module configured to adapt the structured query into a search query compliant with a search facility for obtainment of a search result.

16. The system as claimed in 15, wherein the relevance module is further configured to select from a relevance index a relevance model representative of a set of rules for determining relevance of the search result.

17. The system as claimed in claim 13, wherein the structured query profile is representative of a relationship among functional entities of the functional representation.

18. The system as claimed in claim 13, further comprising a user interaction module configured to ascertain a semantic meaning of the search string according to a change in state of the structured query and a change in state of the search criteria form.

19. The system as claimed in claim 18, wherein the user interaction module is further configured to update the functional query index according to the ascertained semantic meaning of the search string.

20. (canceled)

21. The system as claimed in claim 18, wherein the user interaction module is further configured to update the structured query profile according to the ascertained semantic meaning of the search string.

22. The system as claimed in claim 13, wherein:
the parametric representation comprises at least one parametric entity;
the functional representation comprises at least one functional entity; and
the functional query index comprises an entry representative of a relationship between the at least one parametric entity and the at least one functional entity.

23. The system as claimed in claim 13, further comprising a parameterisation module configured to parse the search string to obtain the parametric representation.

24. The system as claimed in claim 13, further comprising a parameterisation module configured to adapt the parametric representation for compliance with the functional query index.

25. A computer-readable medium for obtaining a structured query from a search string, said computer-readable medium comprising instructions for:
obtaining a functional representation from a parametric representation of the search string according to a functional query index; and
obtaining a structured query from the functional representation according to a structured query profile.

26.-36. (canceled)
